(19) United States
(12) Patent Application Publication
(10) Pub. No.: US 2023/0172242 A1
(43) Pub. Date: Jun. 8, 2023

(54) MICROALGAE-BASED EGG SUBSTITUTE

(71) Applicant: ALGAMA, Paris (FR)

(72) Inventors: Pauline BARRE, Mantes-La-Jolie (FR); Camille TRAORE, Issy-les-Moulineaux (FR)

(21) Appl. No.: 17/999,090

(22) PCT Filed: May 19, 2021
(86) PCT No.: PCT/FR2021/050890

§ 371 Date: Nov. 17, 2022

(30) Foreign Application Priority Data
May 19, 2020 (FR) 2005043

(51) Int. Cl. A23L 15/00; A23L 17/60; A23L 33/185; A23L 5/43; A21D 2/18; A21D 2/26; A21D 2/36

(52) U.S. Cl. CPC A23L 15/35; A23L 17/60; A23L 33/185; A23L 5/43; A21D 2/186; A21D 2/264; A21D 2/36; A21D 2/183

(57) ABSTRACT

The present invention relates to a microalgae-based egg substitute for, according to an embodiment, reducing the fat and sugar content of a food product incorporating same. The invention also relates to the method for obtaining the microalgae-based egg substitute, comprising steps of adding various components including a microalgae product. Finally, the invention also relates to the use of the egg substitute in a food product, a method for incorporating the egg substitute into the preparation of a food product, and the food product comprising the egg substitute.

### FIELD OF THE INVENTION

The present invention relates to a microalgae-based egg substitute for, according to an embodiment, reducing the fat and sugar content of a food product incorporating same. The invention also relates to the method for obtaining the microalgae-based egg substitute, comprising steps of adding various components including a microalgae product. Finally, the invention also relates to the use of the egg substitute in a food product, a method for incorporating the egg substitute into the preparation of a food product, and the food product comprising the egg substitute.

### PRIOR ART

The egg is an essential product in food-processing industries. Because of its versatility, it is present in various food-processing sectors, but its most important use remains in the bakery, patisserie, viennoiserie and cookie fields. It can be found in all products such as sponge cakes, pastry bases, dry cookies and brioche preparations.

However, the issues with eggs are growing, mainly in terms of:
Animal welfare: living conditions of laying hens, life span of laying hens (slaughter as soon as the number of eggs laid drops, debates about the slaughter techniques of male chicks which are “useless” for this industry), etc.
Environment: pollution from mass breeding, transport, heating, origin of food, etc.
Nutrition: issues of cholesterol, saturated fatty acids, allergies
Public health: eggs with fipronil, salmonella, etc.
Costs: instability of egg prices

For some or all of these reasons, consumers, especially vegans, flexitarians and vegetarians, are looking for a sustainable alternative to eggs that is allergen-free, low in saturated fat and can replace eggs in a variety of everyday products.

Egg “replacement” ingredients do exist and are often used in simple preparations, such as the use of a mashed banana, water-soaked flax or chia seeds and apple sauce, but these options only serve a binding function and not the more technical functions of eggs.

Vegan egg substitutes, such as VeganEgg from Follow Your Heart, may contain contentious ingredients, such as certain controversial additives (tetrasodium pyrophosphate, sodium carboxymethylcellulose, etc.) and/or certain allergens such as soy or lupine.

Furthermore, obesity across the world has tripled since 1975. The main cause is the increase in the consumption of fats and sugar.

The consumption of sweetened snack products, including cookies and cakes, is huge, in particular in Europe, the USA and Mexico. This consumption contributes to the epidemic of obesity and excess weight among adults but also among younger people. In fact, most of the added sugar intake comes from this type of product (36% to 61% for adults and 40% to 50% for children in Europe). These snack products are very often high in fat. Excessive consumption of fat is correlated with excess weight and obesity as well as other types of diseases such as diabetes and cardiovascular diseases.

Thus, there is still a need for an egg substitute that retains the technical properties of the egg and also makes it possible, according to one embodiment, to reduce the fat and sugar content of the food products in which said substitute is incorporated, without significantly changing the appearance of said food product and its organoleptic qualities.

To this end, the Applicant has developed an egg substitute which is based on products from microalgae and meets these requirements. This egg substitute is versatile, easy to use, has an attractive nutritional profile, is healthy, serves the essential functions of the egg, and can be used in particular in snack, pastry and bakery preparations, and can be used, according to one embodiment, to lower the levels of sugars and/or fats in these preparations, without changing the organoleptic qualities.

### DESCRIPTION OF THE INVENTION

To this end, according to a first aspect of the invention, a microalgae-based egg substitute is proposed, characterized by comprising:
40% to 90%, preferably 40% to 80%, more preferably 50% to 75%, by total weight of said substitute, of at least one non-microalgal vegetable flour and/or at least one non-microalgal vegetable starch;
8% to 30%, preferably 10% to 30%, more preferably 12% to 24%, by total weight of said substitute, of at least one non-microalgal vegetable protein;
1% to 15%, preferably 3 to 15%, more preferably 5% to 12%, by total weight of said substitute, of at least one product from microalgae;
0.2% to 10%, preferably 0.2% to 5%, by total weight of said substitute, of at least one non-microalgal vegetable fiber;
0.1% to 2%, by total weight of said substitute, of at least one thickener of vegetable origin.

According to the invention, an egg substitute is understood to mean a mixture for mimicking the intrinsic properties of the whole egg, i.e., its thickening and binding capability, and for making the obtained food products soft, thus making it unnecessary to add egg to the preparation.

Said substitute may be in powder form or as a liquid mixture with water.

Preferably, according to the invention, said egg substitute comprises 0.1% to 16%, by total weight of said substitute, of at least one dye.

Preferably, according to the invention, said egg substitute comprises 0.1% to 16%, by total weight of said substitute, of at least one flavoring.

According to one embodiment, flavorings are added when said substitute is also intended to reduce the levels of sugar and fat in the food product in which said substitute will be incorporated.

According to the invention, vegetable flour is understood to mean fine powders obtained by grinding any type of cereal, legume or even fruit.

According to the invention, vegetable starch is understood to mean a granular amylaceous material of variable dimensions, extracted from various plant organs, such as tubers, rhizomes and cereals.

Preferably, according to the invention, said at least one non-microalgal vegetable flour and/or non-microalgal vegetable starch is selected from: rice flour, corn flour, wheat flour, tapioca flour, lentil flour, quinoa flour, pea flour, millet flour, chickpea flour, buckwheat flour, corn starch, potato starch, rice starch, tapioca starch.

According to the invention, vegetable protein is understood to mean protein extracted from plants.

Preferably, according to the invention, said at least one non-microalgal vegetable protein is selected from: dehydrated aquafaba, chia protein, rice protein, pea protein, fava bean protein, flax protein, mung bean protein, chickpea protein, pea protein, potato protein, lentil protein.

According to the present invention, microalgae is intended to mean: eukaryotic microalgae, which are characterized by a nucleus, including for example chlorophytes, rhodophytes, haptophytes, bacillariophytes, eustigmatophytes, euglenophytes, thraustochytriaceae and dinophytes, said eukaryotic microalgae being commonly referred to as “microalgae”; and prokaryotic microalgae, which do not have a nucleus, including cyanophytes, hereinafter referred to specifically as “cyanobacteria.”

Preferably, according to the invention, said at least one product from microalgae is from: Chlorophyte species, preferably selected from Chlorella, Auxenochlorella, Dunaliella, Tetraselmis, Haematococcus, Scenedesmus; eustigmatophyte species, preferably Nannochloropsis; euglenophyte species, preferably Euglena; rhodophyte species, preferably Porphyridium; bacillariophyceae species, preferably Phaeodactylum and Odontella; and thraustochytriaceae species, preferably Schizochytrium.

Preferably, according to the invention, the cyanobacteria are selected from spirulina (Arthrospira platensis or maxima) and AFA (Aphanizomenon Floes-aquae).

Preferably, said at least one product from microalgae is selected from: microalgae flour, protein from microalgae, lipids from microalgae, extracts from microalgae.

Preferably, said at least one product from microalgae is from: Chlorophyte species, preferably selected from Chlorella, Auxenochlorella, Dunaliella, Tetraselmis, Haematococcus, Scenedesmus; eustigmatophyte species, preferably Nannochloropsis; euglenophyte species, preferably Euglena; rhodophyte species, preferably Porphyridium; bacillariophyceae species, preferably Phaeodactylum and Odontella; and thraustochytriaceae species, preferably Schizochytrium.

According to one embodiment of the invention, said at least one product from microalgae is from Chlorella or Arthrospira.

According to the invention, non-microalgal is understood to mean that the mentioned component does not come from a microalgal source, but from another vegetable source.

According to the invention, vegetable fiber is understood to mean filiform and dead cell expansions, mainly composed of cellulose, hemicelluloses, lignins, and pectins, (physically, enzymatically or chemically) transformed carbohydrate polymers of vegetable origin, associated or not associated in the plant with lignin or other non-carbohydrate constituents (polyphenols, waxes, saponins, cutin, phytates, phytosterols, etc.).

Preferably, according to the invention, said at least one non-microalgal vegetable fiber is selected from: oat fiber, wheat fiber, carrot fiber, apple fiber, citrus fiber, lemon fiber, psyllium fiber.

According to the invention, a thickener is understood to mean a component for increasing the consistency and viscosity of a more or less liquid preparation. Said thickener gives the food a firm hold.

Preferably, according to the invention, said at least one thickener of vegetable origin is selected from: guar gum, xanthan gum, gellan gum, locust bean gum, gum arabic, tara gum, pectin, alginate, agar, carrageenans, cellulose and derivatives thereof.

According to the invention, a dye is understood to mean an additive or foodstuff with coloring properties for giving color to the product.

According to the present invention, a flavoring is understood to mean a food additive for giving a taste and/or a smell to the product.

Preferably, said at least one dye is selected from: dyes of synthetic origin, dyes of natural origin, spices.

Preferably, said at least one flavoring is selected from: synthetic flavorings, natural flavorings, spices.

Examples of flavorings are: vanilla flavorings, cream flavorings, butter flavoring.

Examples of dyes are: turmeric, curcumin, beta-carotene, tomato powder, carrot powder.

The egg substitute according to the invention is vegan, allergen-free, cholesterol-free, gluten-free. In one embodiment, said egg substitute can also help to reduce lipids, saturated fatty acids, sugar, cholesterol and sodium.

Concerning the lipids, said substitute according to the invention comprises less than 2% lipids, whereas a powdered egg will have more than 42% lipids.

Composition example according to the invention with a flavoring:

TABLE 1
Composition 1 (%)

| | |
|---|---|
| Chia protein | 24 |
| Lemon fiber | 1.8 |
| Rice flour + corn starch | 60.3 |
| Xanthan gum | 0.6 |
| Microalgae: Chlorella | 12 |
| Vanilla flavoring | 0.1 |
| Carrot powder + tomato | 1.2 |
| powder | |

Composition example according to the invention with a flavoring:

TABLE 2
Composition 2 (%)

| | |
|---|---|
| Rice protein | 21.9 |
| Psyllium fiber | 5 |
| Potato starch | 51.9 |
| Xanthan gum | 0.9 |
| Microalgae: Extracts of | 10 |
| Arthrospira | |
| Vanilla flavoring + cream | 14 |
| flavoring | |
| Tomato powder + turmeric | 1.4 |

Composition example according to the invention without a flavoring:

TABLE 3
Composition 3 (%)

| | |
|---|---|
| Pea protein | 18 |
| Wheat fiber | 2 |
| Corn starch + tapioca | 66.5 |
| starch | |
| Guar gum | 1.5 |
| Microalgae: Arthrospira | 11 |
| extract | |
| Turmeric | 1 |

Composition example according to the invention without a flavoring:

TABLE 4
Composition 4 (%)

| | |
|---|---|
| Chickpea protein | 17 |
| Oat fiber | 1.8 |
| Corn starch + potato | 71.3 |
| starch | |
| Guar gum | 1.2 |
| Microalgae: Chlorella | 8 |
| Carrot powder | 0.7 |

According to a second aspect, the invention relates to a process for obtaining a microalgae-based egg substitute according to the invention, comprising at least one step for mixing said components, preferably at between 100 and 3,000 rpm, more preferably at between 100 and 1,000 rpm, even more preferably at 500 rpm, preferably for between 60 and 350 seconds, more preferably for between 60 and 120 seconds, even more preferably for 90 seconds.

Components are understood to mean the various products added to the preparation, in particular at least one non-microalgal vegetable flour and/or at least one non-microalgal vegetable starch, at least one non-microalgal vegetable protein, at least one product from microalgae, at least one non-microalgal vegetable fiber, at least one thickener of vegetable origin, at least one dye.

According to one embodiment, said method for obtaining a microalgae-based egg substitute according to the invention comprises the steps of:
a. mixing, while stirring at between 100 and 3,000 rpm, preferably at between 100 and 1,000 rpm, more preferably at 500 rpm, for between 60 and 350 seconds, preferably for between 60 and 120 seconds, more preferably for 90 seconds:
   at least one thickener of vegetable origin; and
   optionally at least one dye and/or at least one flavoring;
b. adding, to the mixture obtained in step a., while stirring at between 100 and 3,000 rpm, preferably at between 100 and 1,000 rpm, more preferably at 500 rpm, for between 60 and 350 seconds, preferably for between 60 and 120 seconds, more preferably for 90 seconds:
   at least one product from microalgae; and
   at least one non-microalgal vegetable fiber;
c. adding, to the mixture obtained in step b., at between 100 and 3,000 rpm, preferably at between 100 and 1,000 rpm, more preferably at 500 rpm, for between 60 and 350 seconds, preferably for between 60 and 120 seconds, more preferably for 90 seconds:
   at least one non-microalgal vegetable flour and/or non-microalgal vegetable starch; and
   at least one non-microalgal vegetable protein;
d. optionally, mixing the egg substitute in powder form obtained in step c. with water, preferably at a ratio of one part powder obtained in step c. to 6 to 9 parts water, at between 100 and 5,000 rpm, preferably at between 500 and 2,000 rpm, more preferably at 800 rpm, for 3 to 7 minutes;
e. obtaining a microalgae-based egg substitute.

The stirring in the various steps of the method according to the invention can be done by different types of mixers, for example mobile tank mixers, blenders, screw mixers, etc.

Said components used in the method according to the invention and the egg substitute obtained in step c. are in powder form.

The optional step d. makes it possible to obtain a “liquid” version of said substitute.

According to a third aspect, the invention relates to the use of the egg substitute according to the invention in the preparation of a food product, preferably in the preparation of sponge cakes, dessert bases, dessert dough, patisseries, viennoiseries, bakery products, or cookies.

According to a fourth aspect, the invention relates to a method for incorporating the microalgae-based egg substitute according to the invention into a food product, comprising incorporating between 0.5 and 5%, by total weight of the food product, of the microalgae-based egg substitute according to the invention into the preparation of the food product.

According to the invention, incorporating is understood to mean the addition of the substitute according to the invention to the preparation with the other components.

According to a fifth aspect, the invention relates to a food product comprising between 0.5 and 5%, by weight of said food product, of the microalgae-based egg substitute according to the invention.

According to one embodiment, said microalgae-based egg substitute according to the invention is added to a preparation of baked goods, preferably brioche bread, with a content of 2.1% by weight of the total preparation.

According to one embodiment, said microalgae-based egg substitute according to the invention is added to a cookie preparation with a content of 1% by weight of the total preparation.

According to one embodiment, said microalgae-based egg substitute according to the invention is added to a cupcake preparation with a content of 3.4% by weight of the total preparation.

Said egg substitute according to the invention may be in powder form as obtained in step d. of the method according to the invention, or in liquid form as obtained in step e. of the method according to the invention.

Preferably, the fat content of the food product in which the substitute according to the invention is incorporated is reduced by a quantity of up to 50%.

Preferably, the sugar content of the food product in which the substitute according to the invention is incorporated is reduced by a quantity of up to 15%.

Products with a reduced-fat content of up to 50% and/or a reduced-sugar content of up to 15% are made with the microalgae-based egg substitute according to the invention comprising at least one flavoring.

In order to achieve these reductions in sugar and fat concentration, the preparations are made by adding less sugar and fat and more of other elements such as water or flour, the incorporated egg substitute according to the invention compensating for this reduction in sugar and fat in the obtained finished product in terms of consistency and organoleptic properties.

### DESCRIPTION OF THE DRAWINGS

FIG. 1 shows the comparative colorimetric analysis of two preparations of the same pastry (milk bread and donut) with egg or with the substitute according to the invention.

FIG. 2 is a diagram describing the deviation from reference for the “cohesiveness to the touch” attribute for the analysis of Example 9 for light (A1) and non-light (A2) brioches.

FIG. 3 is a diagram describing the deviation from reference for the “cohesiveness to the touch” attribute for the analysis of Example 10 for a non-light cookie.

FIG. 4 is a diagram describing the crumb firmness results for the light brioche (A1) shown in Example 11.

### EXAMPLES

### Example 1: Preparation of a Microalgae-Based Egg Substitute According to the Invention

A microalgae-based egg substitute is prepared by the method according to the invention.

The following are mixed, while stirring at 500 rpm, for 90 seconds:
0.6% of vegetable xanthan gum by weight of the final product; and
1.2% of a mixture of carrot powder and tomato powder by weight of the final product, and 0.1% of vanilla flavoring by weight of the final product.

The following are then mixed with the mixture obtained above, while stirring at 500 rpm, for 90 seconds:
12% of a product from microalgae (Chlorella) by weight of the final product; and
1.8% of lemon fiber by weight of the final product.

The following are then mixed with the mixture obtained above, while stirring at 500 rpm, for 90 seconds:
60.3% of rice flour and corn starch by weight of the final product; and
24% of chia protein by weight of the final product.

A microalgae-based egg substitute, in powder form, is thus obtained, which makes it possible, depending on the use thereof and the other products used to prepare the food product, to reduce the fat and sugar content of the food product in which said substitute is incorporated.

Said obtained egg substitute corresponds to the composition example in Table 1.

### Example 2: Comparative Colorimetric Analysis of Two Preparations of the Same Pastry (Milk Bread and Donut) with Egg or with the Substitute According to the Invention, Showing the Preservation of the Yellow Levels

A first preparation was made with egg, and the second was made with the substitute according to the invention. Statistical analysis of the data was done with Statpoint for comparison of averages.

The analysis is performed on two different types of pastries.

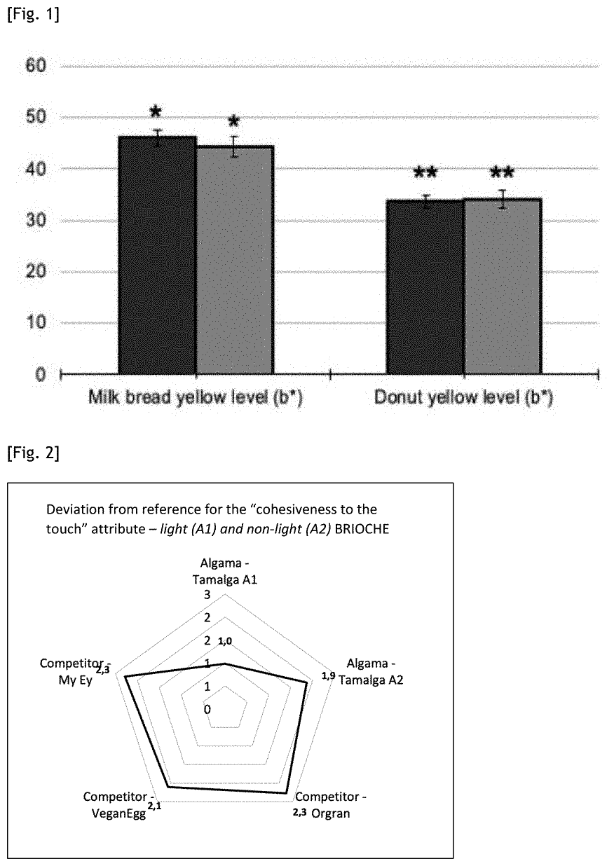

The results are shown in FIG. 1.

The colorimetric analysis showed no statistical difference between the preparations with eggs and those with the egg substitute according to the invention. In fact, the analysis of the comparison of averages of the B index (yellow level of the CIELAB standard) showed no statistical difference with a 95% confidence level.

### Example 3: Use of the Substitute According to the Invention in the Preparation of Cupcakes

To prepare cupcakes, the following ingredients are added in the quantities listed in Table 5:

Composition of cupcake preparation:

TABLE 5
Composition (%)

| | |
|---|---|
| Flour | 26.8 |
| Sugar | 24.3 |
| Vegetable fats | 19.4 |
| Water | 24.8 |
| Yeast | 1.3 |
| Egg substitute | 3.4 |
| according to the invention | |

### Example 4: Use of the Substitute According to the Invention in the Preparation of Cupcakes with 50% Less Fat

To prepare cupcakes with a reduced fat content, the following ingredients are added in the quantities listed in Table 6:

Composition of Cupcake Preparation:

TABLE 6
Composition (%)

| | |
|---|---|
| Flour | 36.5 |
| Sugar | 24.3 |
| Vegetable fats | 9.7 |
| Water | 24.8 |
| Yeast | 1.3 |
| Egg substitute according | 3.4 |
| to the invention | |

### Example 5: Use of the Substitute According to the Invention in the Preparation of Cookies

To prepare cookies, the following ingredients are added in the quantities listed in Table 7:

Composition of cookie preparation:

TABLE 7
Composition (%)

| | |
|---|---|
| Flour | 31.7 |
| White sugar | 14.1 |
| Cane sugar | 15.6 |
| Vegetable fats | 15.6 |
| Chocolate chips | 14.1 |
| Water | 7.2 |
| Yeast | 0.7 |
| Egg substitute according | 1 |
| to the invention | |

### Example 6: Use of the Substitute According to the Invention in the Preparation of Cookies with 15% Less Fat and Sugar

To prepare cookies with a reduced fat content, the following ingredients are added in the quantities listed in Table 8:

Composition of cookie preparation:

TABLE 8
Composition (%)

| | |
|---|---|
| Flour | 35.2 |
| White sugar | 12 |
| Cane sugar | 13.2 |
| Vegetable fats | 13.2 |
| Chocolate chips | 14.1 |
| Water | 10.6 |
| Yeast | 0.7 |
| Egg substitute according | 1 |
| to the invention | |

### Example 7: Preparation of a Microalgae-Based Egg Substitute According to the Invention (with a Flavoring)

A microalgae-based egg substitute is prepared by the method according to the invention by following the example of the compositions according to Tables 1 and 2.

The following are mixed, while stirring at 500 rpm, for 90 seconds:
a thickener of vegetable origin; and
a dye and the flavoring(s).

The following are then mixed with the mixture obtained above, while stirring at 500 rpm, for 90 seconds:
the product from microalgae; and
the non-microalgal vegetable fiber.

The following are then mixed with the mixture obtained above, while stirring at 500 rpm, for 90 seconds:
the non-microalgal vegetable flour and/or non-microalgal vegetable starch; and
the non-microalgal vegetable protein.

A microalgae-based egg substitute, in powder form, is thus obtained, which makes it possible, depending on the use thereof and the other products used to prepare the food product, to substitute the egg, and which can reduce the fat and sugar content of the food product in which said substitute is incorporated.

### Example 8: Preparation of a Microalgae-Based Egg Substitute According to the Invention (without a Flavoring)

A microalgae-based egg substitute is prepared by the method according to the invention by following the example of the compositions according to Tables 3 and 4.

The following are mixed, while stirring at 500 rpm, for 90 seconds:
a thickener of vegetable origin; and
the dye.

The following are then mixed with the mixture obtained above, while stirring at 500 rpm, for 90 seconds:
the product from microalgae; and
the non-microalgal vegetable fiber.

The following are then mixed with the mixture obtained above, while stirring at 500 rpm, for 90 seconds:
the non-microalgal vegetable flour and/or non-microalgal vegetable starch; and
the non-microalgal vegetable protein.

A microalgae-based egg substitute is thus obtained, in powder form, which makes it possible, depending on the use thereof and the other products used to prepare the food product, to substitute the egg.

### Example 9: Evaluation of the Difference in the Perception of Cohesiveness to the Touch Between Brioches Made from Egg and Brioches and Cookies Made from the Egg Substitute Prepared According to the Invention or from Competitor Egg Substitutes

The method according to the invention is used to produce an egg substitute for recipes according to Example 8.

The ability of the egg substitute prepared according to the invention to act as a binder within two cereal matrices—brioches and cookies—is tested and compared with the ability of competitor egg substitutes.

12.05% (w/v) solutions of egg and of each egg substitute are prepared in water at 20° C. and mixed at 1,000 rpm for 3 minutes. The samples tested in this test are shown in Table 9.

TABLE 9

| Egg substitutes tested | Concentration of |
|---|---|
| in Example 9 | the solution |
| Gallia whole egg powder | 12.05% (w/v) |
| Egg substitute prepared according | |
| to Example 8 | |
| Competitor 1: Volley from MyEY | |
| Competitor 2: VeganEGG from | |
| Follow your Heart | |
| Competitor 3: No EGG from Orgran | |

The used cereal products selected for the test are brioches and cookies that have traditional recipes and thus are not light versions.

The formula, order of incorporation of the ingredients and the mixing phase parameters (speed, duration) used to make the brioche matrix are shown in Table 10.

The formulas are made with a planetary mixer (for example, a 5KSM150 model from Kitchen Aid, USA) provided with the hook tool for brioches.

1.3 kg batches are made for the brioches.

TABLE 10
Formula, order of incorporation of ingredients and
mixing parameters of the non-light brioche

| | | Order of incorporation, |
|---|---|---|
| | Quantity | phase and mixing parameters |
| Ingredient | (%) | (speed, duration) |
| Plant milk | 18.4 | 1; dilute with a whisk for |
| Instant yeast | 1.5 | 30 seconds |
| Sugar | 7.3 | 2; whisk for 1 minute |
| Egg or powder/egg | 17 | |
| substitute powder in | | |
| solution according to | | |
| Table 9 | | |
| Margarine | 11 | 3; stand mixer: speed |
| Salt | 0.7 | 2-6 minutes |
| Flour | 44.1 | |

When the dough is uniform, cover and let it rise for 30 minutes at 30° C.

De-gas the dough.

Put the dough in a mold.

Brush plant milk on top of the dough.

Cover and let it rise for 30 minutes at 35° C.

Bake at 180° C. for 30 minutes.

Allow the product to cool for 90 minutes at 20° C.

Once cooled, the brioches are placed in zipped freezer bags and stored until the sensory measurements are carried out, which take place within a maximum of 6 hours.

The formula, order of incorporation of ingredients and mixing phase parameters (speed, duration) used to make the cookie matrix are shown in Table 11.

The formulas are made using a planetary mixer (e.g., a model 5KSM150 from Kitchen Aid, USA) equipped with the flat beater tool for cookies.

1 kg batches are made for the cookies.

TABLE 11
Formula, order of incorporation of ingredients and
mixing parameters of the non-light cookie

| | | Order of incorporation and |
|---|---|---|
| | Quantity | mixing parameters (speed, |
| Ingredient | (%) | duration) |
| White sugar | 14.1 | 1; stand mixer: speed 0.5: |
| Brown sugar | 15.6 | 1 minute |
| Margarine | 15.6 | |
| Egg or powder/egg | 8.2 | 2; stand mixer: speed 1: |
| substitute powder in | | 1 minute |
| solution according to | | |
| Table 9 | | |
| Flour | 31.7 | 3; stand mixer: speed 1: |
| Chemical yeast | 0.7 | 1 minute |
| Chocolate chips | 14.1 | 4; stand mixer: speed 0.5: |
| | | 0.5 minutes |

Form small balls on a baking tray and flatten slightly.

Bake for 25 minutes at 150° C.

Allow to cool for 60 minutes at 20° C.

Once cooled, the cookies are placed in zipped freezer bags and stored until the sensory measurements are carried out, which take place within a maximum of 6 hours.

Five batches of each type of cereal product are made, each time using one of the five egg or egg substitute solutions shown in Table 9.

The ability of egg substitutes to act as a binder in brioches and cookies is evaluated by a sensory measurement of cohesiveness to the touch.

The sensory measurement is performed using a naive panel of 10 consumers in the form of a “deviation from reference” test (NF ISO 13299:2016 standard).

The “deviation from reference” test consists in quantifying the deviation of a defined attribute of each evaluated product, in this case “cohesiveness to the touch,” from a defined reference, in this case the products made from whole egg powder.

The panelists evaluate the perceived difference in cohesiveness to the touch on a discontinuous linear scale from 0 to 10, with 0 corresponding to complete similarity in “cohesiveness to the touch” between the product made from an egg substitute and the reference, which corresponds to the product made from egg, and with 10 corresponding to complete dissimilarity between these products.

The panelists are asked to evaluate the “cohesiveness to the touch” according to the following definition and protocol:
Definition for brioches: the degree to which the crumb holds/does not easily disintegrate into particles when rubbed between the thumb and a finger or between two hands.
Analysis protocol for brioches: Break the slice in half, and on one half of the slice, evaluate the hold of the crumb by rubbing it between the thumb and a finger or between two hands. The product is cohesive if no crumbs are formed.
Definition for cookies: the degree to which the cookie holds/does not easily disintegrate into particles when broken.
Analysis protocol for cookies: Break the cookie in half, and evaluate how well the cookie holds by observing the amount of crumbs from the break. The product is cohesive if no crumbs are formed.

The panelists are asked to start by evaluating the reference product, i.e., the brioche or cookie made from whole egg powder. Then, each panelist evaluates each of the four products made from an egg substitute, in a random order.

All the samples tested by the panelists are anonymized with a 3-digit code so that the panelists do not know what the samples correspond to and how the methods for making the samples differ.

Once the test results are returned by the panelists, the distance between the reference (0 marker of the scale) and the placement for each product on the linear scale by each panelist is measured and recorded on a computer for statistical processing.

An analysis of variances over the set of deviation-from-reference values for “cohesiveness to the touch” is performed in order to analyze the influence of the type of egg substitute and the change of panelist on the perceived difference from the reference in terms of “cohesiveness to the touch.”

The deviation-from-reference results for the “cohesiveness to the touch” attribute for the non-light brioche presented in this example are shown in FIG. 2 as “A2.” These results are expressed as mean values for all the panelists, on a scale ranging from 0 to 10 in accordance with the discontinuous linear scale used in the test.

In FIG. 2, the reference, which corresponds to the cohesiveness to the touch of a non-light brioche made from whole egg powder, is represented by the ring with a value of 0.

Across the data set, the analysis of variances showed a significant effect of the type of egg substitute on the perception of “cohesiveness to the touch,” irrespective of the change in panelist, with a 5% confidence level.

According to these results, the brioche made from the egg substitute prepared according to Example 8 (A2) obtains an average deviation-from-reference score of 1.9, which corresponds to the second closest score to the reference after the brioche made from the egg substitute prepared according to Example 7 (A1).

The method conditions according to Example 8 thus make it possible to obtain a non-light brioche with a “cohesiveness to the touch” that is perceived by the panelists to be closer to the whole-egg reference than the brioches made with the competitor egg substitutes.

This result reflects an improved ability of the substitute prepared according to the invention to act as a binder within a non-light brioche matrix in comparison with the competitor egg substitutes.

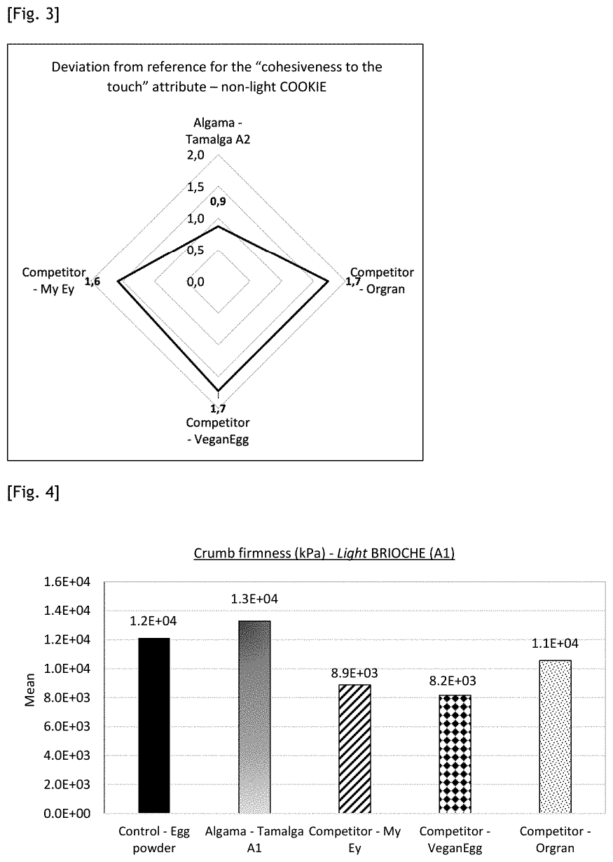

The deviation-from-reference results for the “cohesiveness to the touch” attribute for the non-light cookie presented in this example are shown in FIG. 3. These results are expressed as mean values for all the panelists, on a scale ranging from 0 to 10 in accordance with the discontinuous linear scale used in the test.

In FIG. 3, the reference, which corresponds to the cohesiveness to the touch of a non-light cookie made from whole egg powder, is represented by the ring with a value of 0.

Across the data set, the analysis of variances showed a significant effect of the type of egg substitute on the perception of “cohesiveness to the touch,” irrespective of the change in panelist, with a 5% confidence level.

According to these results, the cookie made from the egg substitute prepared according to Example 8 (A2) obtains an average deviation-from-reference score of 0.9, which corresponds to the closest score to the reference.

The method conditions according to Example 8 thus make it possible to obtain a non-light cookie with a “cohesiveness to the touch” that is perceived by the panelists to be closer to the whole-egg reference than the brioches made with the competitor egg substitutes.

This result reflects an improved ability of the substitute prepared according to the invention to act as a binder within a non-light cookie matrix in comparison with the competitor egg substitutes.

### Example 10: Evaluation of the Difference in the Perception of Cohesiveness to the Touch Between Low-Fat Brioches Made from Egg and Low-Fat Brioches Made from the Egg Substitute Prepared According to the Invention or from Competitor Egg Substitutes

The method according to the invention is used to produce an egg substitute for light recipes according to Example 7.

The ability of the egg substitute prepared according to the invention to act as a binder within low-fat brioche matrices is tested and compared with the ability of competitor egg substitutes.

12.05% (w/v) solutions of egg and of each egg substitute are prepared in water at 20° C. and mixed at 1,000 rpm for 3 minutes. The samples tested in this test are shown in Table 9.

The used cereal products selected for the test are brioches with a 30% fat reduction.

The formula, order of incorporation of the ingredients and mixing phase parameters (speed, duration) used to make the brioche matrix are shown in Table 12.

The formulas are made with a planetary mixer (for example, a 5KSM150 model from Kitchen Aid, USA) provided with the hook tool for brioches.

1.3 kg batches are made for the brioches.

TABLE 12
Formula, order of incorporation of ingredients and mixing
parameters of the brioche with a 30% fat reduction

| | | Order of incorporation and |
|---|---|---|
| | Quantity | mixing parameters (speed, |
| Ingredient | (%) | duration) |
| Plant milk | 19.1 | 1; dilute with a whisk for |
| Instant yeast | 1.5 | 30 seconds |
| Sugar | 7.6 | 2; whisk for 1 minute |
| Egg or powder/egg | 17.7 | |
| substitute powder in | | |
| solution according to | | |
| Table 9 | | |
| Margarine | 7.6 | 3; stand mixer: speed 2-6 |
| Salt | 0.8 | minutes |
| Flour | 45.7 | |

When the dough is uniform, cover and let it rise for 30 minutes at 30° C.

De-gas the dough.

Place the dough in a mold.

Brush plant milk on top of the dough.

Cover and let it rise for 30 minutes at 35° C.

Bake at 180° C. for 30 minutes.

Allow to cool for 90 minutes at 20° C.

Once cooled, the brioches are placed in zipped freezer bags and stored until the sensory measurements are carried out, which take place within a maximum of 6 hours.

Five batches of each type of cereal product are made, each time using one of the five egg or egg substitute solutions shown in Table 9.

The ability of the egg substitutes to act as a binder in the brioches is evaluated by a sensory measurement of cohesiveness to the touch.

The sensory measurement is performed using a naive panel of 10 consumers in the form of a “deviation from reference” test (NF ISO 13299:2016 standard).

The “deviation from reference” test consists in quantifying the deviation of a defined attribute of each evaluated product, in this case “cohesiveness to the touch,” from a defined reference, in this case the products made from whole egg powder.

The panelists evaluate the perceived difference in cohesiveness to the touch on a discontinuous linear scale from 0 to 10, with 0 corresponding to complete similarity in “cohesiveness to the touch” between the product made from an egg substitute and the reference, which corresponds to the product made from egg, and with 10 corresponding to complete dissimilarity between these products.

The panelists are asked to evaluate the “cohesiveness to the touch” according to the following definition and protocol:
Definition: the degree to which the crumb holds/does not easily disintegrate into particles when rubbed between the thumb and a finger or between two hands.
Analysis protocol: Break the slice in half, and on one half of the slice, evaluate the hold of the crumb by rubbing it between the thumb and a finger or between two hands. The product is cohesive if no crumbs are formed.

The panelists are asked to start by evaluating the reference product, i.e., the brioche made from whole egg powder. Then, each panelist evaluates each of the four products made from an egg substitute, in a random order.

All the samples tested by the panelists are anonymized with a 3-digit code so that the panelists do not know what the samples correspond to and how the methods for making the samples differ.

Once the test results are returned by the panelists, the distance between the reference (0 marker of the scale) and the placement for each product on the linear scale by each panelist is measured and recorded on a computer for statistical processing.

An analysis of variances over the set of deviation-from-reference values for “cohesiveness to the touch” is performed in order to analyze the influence of the type of egg substitute and the change of panelist on the perceived difference from the reference in terms of “cohesiveness to the touch.”

The deviation-from-reference results for the “cohesiveness to the touch” attribute for the light brioche presented in this example are shown in FIG. 2 as “A1.” These results are expressed as mean values for all the panelists, on a scale ranging from 0 to 10 in accordance with the discontinuous linear scale used in the test.

In FIG. 2, the reference, which corresponds to the cohesiveness to the touch of a light brioche made from whole egg powder, is represented by the ring with a value of 0.

Across the data set, the analysis of variances showed a significant effect of the type of egg substitute on the perception of “cohesiveness to the touch,” irrespective of the change in panelist, with a 5% confidence level.

According to these results, the brioche made from the egg substitute prepared according to Example 7 (A1) obtains an average deviation-from-reference score of 1.0, which corresponds to the closest score to the reference.

The method conditions according to Example 7 thus make it possible to obtain a light brioche with a “cohesiveness to the touch” that is perceived by the panelists to be closer to the whole-egg reference than the brioches made with the competitor egg substitutes.

This result reflects an improved ability of the substitute prepared according to the invention to act as a binder in a light brioche matrix in comparison with the competitor egg substitutes.

### Example 11: Comparison of Instrument-Based Evaluation of Softness Between Low-Fat Brioches Made from Egg and Low-Fat Brioches Made from the Egg Substitute Prepared According to the Invention or from Competitor Egg Substitutes

The method according to the invention is used to produce an egg substitute for light recipes according to Example 7.

The ability of the egg substitute prepared according to the invention to provide softness in brioche matrices with a 30% fat reduction is tested and compared with the ability of competitor egg substitutes.

The ability of the egg substitutes to provide softness in brioches and cookies is evaluated by an instrument-based measurement of the firmness of the internal crumb of the brioche.

The instrument-based measurement is performed with a TAHD+ texturometer (Stable Micro Systems, Surrey, UK) equipped with a 50 kg load cell.

Immediately after unpacking the brioche, blocks of internal crumb with standardized dimensions (6 cm×3 cm×3 cm) are cut out using a cutting system.

Two blocks are sampled per brioche, which corresponds to two intra-product repetitions.

Two brioches per production batch are used for the test, corresponding to two intra-batch repetitions.

The test used is a compression test with a 10 cm diameter aluminum tray. The pre-test speed is 1 mm/s, the test speed is 2 mm/s, and the post-test speed is 10 mm/s. The force threshold is 0.5 N. The target compression ratio is 40%.

The curves of obtained values expressed in force (N) versus distance (mm) are processed to extract the gradient at the origin (N/mm). This value is processed to obtain the Young's modulus or modulus of elasticity (kPa) of the crumb.

The Young's modulus represents the rigidity of the crumb of the brioche, i.e., its softness.

An analysis of variances across all the Young's modulus values is performed in order to analyze the influence of the type of egg substitute and the intra-batch repeatability on the rigidity of the crumb.

The crumb firmness results for the light brioche presented in this example are shown in FIG. 4 as “A1.”

Across the data set, the analysis of variances showed a significant effect of the type of egg substitute on the perception of “cohesiveness to the touch,” irrespective of the intra-batch repeatability, with a 5% confidence level.

According to these results, the brioche made from the egg substitute prepared according to Example 7 (A1) has the crumb firmness closest to that of the whole-egg reference.

In this respect, the brioche made from the egg substitute prepared according to Example 7 (A1) differs from the competitors “My Ey,” “Vegan Egg” and “Orgran,” which all have a crumb firmness that is inferior to that of the whole-egg reference.

The method conditions according to Example 7 thus make it possible to obtain a light brioche with an instrument-measured softness closer to the whole-egg reference than the brioches made with the competitor egg substitutes.

This result reflects an improved ability of the substitute prepared according to the invention to provide softness in a light brioche matrix in comparison with the competitor egg substitutes.

1. A microalgae-based egg substitute, in powder form, characterized by comprising:
40% to 90%, preferably 40% to 80%, more preferably 50% to 75%, by total weight of said substitute, of at least one non-microalgal vegetable flour and/or at least one non-microalgal vegetable starch, said flours and starches being selected from: rice flour, corn flour, wheat flour, tapioca flour, lentil flour, quinoa flour, pea flour, millet flour, chickpea flour, buckwheat flour, corn starch, potato starch, rice starch, tapioca starch;
8% to 30%, preferably 10% to 30%, more preferably 12% to 24%, by total weight of said substitute, of at least one non-microalgal vegetable protein, selected from: dehydrated aquafaba, chia protein, rice protein, pea protein, fava bean protein, flax protein, mung bean protein, chickpea protein, pea protein, potato protein, lentil protein;
1% to 15%, preferably 3% to 15%, more preferably 5% to 12%, by total weight of said substitute, of at least one product from microalgae selected from: microalgae flour, protein from microalgae, lipids from microalgae, extracts from microalgae;
0.2% to 10%, preferably 0.2% to 5%, by total weight of said substitute, of at least one non-microalgal vegetable fiber selected from: oat fiber, wheat fiber, carrot fiber, apple fiber, citrus fiber, lemon fiber, psyllium fiber;
0.1% to 2%, by total weight of said substitute, of at least one thickener of vegetable origin selected from: guar gum, xanthan gum, gellan gum, locust bean gum, gum arabic, tara gum, pectin, alginate, agar, carrageenans, cellulose and derivatives thereof.

2. The microalgae-based egg substitute according to claim 1, characterized by comprising 0.1% to 16%, by total weight of said substitute, of at least one dye.

3. The microalgae-based egg substitute according to claim 2, characterized in that said dye is selected from: turmeric, curcumin, beta-carotene, tomato powder, carrot powder.

4. The microalgae-based egg substitute according to claim 1, characterized by comprising 0.1% to 16%, by total weight of said substitute, of at least one flavoring.

5. The microalgae-based egg substitute according to claim 1, characterized in that said at least one product from microalgae is from: Chlorophyte species, preferably selected from Chlorella, Auxenochlorella, Dunaliella, Tetraselmis, Haematococcus, Scenedesmus; eustigmatophyte species, preferably Nannochloropsis; euglenophyte species, preferably Euglena; rhodophyte species, preferably Porphyridium; bacillariophyceae species, preferably Phaeodactylum and Odontella; and thraustochytriaceae species, preferably Schizochytrium.

6. A method for obtaining a microalgae-based egg substitute according to claim 1, comprising at least one step for mixing the components, preferably at between 100 and 3,000 rpm, preferably at between 100 and 1,000 rpm, more preferably at 500 rpm, preferably for between 60 and 350 seconds, more preferably for between 60 and 120 seconds, even more preferably for 90 seconds.

7. The method for obtaining a microalgae-based egg substitute according to claim 6, comprising the steps of:
a. mixing, while stirring at between 100 and 3,000 rpm, preferably at between 100 and 1,000 rpm, more preferably at 500 rpm, for between 60 and 350 seconds, preferably for between 60 and 120 seconds, more preferably for 90 seconds:
said at least one thickener of vegetable origin; and
optionally said at least one dye and/or said at least one flavoring;
b. adding, to the mixture obtained in step a., while stirring at between 100 and 3,000 rpm, preferably at between 100 and 1,000 rpm, more preferably at 500 rpm, for between 60 and 350 seconds, preferably for between 60 and 120 seconds, more preferably for 90 seconds:
said at least one product from microalgae; and
said at least one non-microalgal vegetable fiber;
c. adding, to the mixture obtained in step b., at between 100 and 3,000 rpm, preferably at between 100 and 1,000 rpm, more preferably at 500 rpm, for between 60 and 350 seconds, preferably for between 60 and 120 seconds, more preferably for 90 seconds:
said at least one non-microalgal vegetable flour and/or non-microalgal vegetable starch; and
said at least one non-microalgal vegetable protein;
d. optionally, mixing the egg substitute in powder form obtained in step c. with water, preferably at a ratio of one part powder obtained in step c. to 6 to 9 parts water, at between 100 and 5,000 rpm, preferably at between 500 and 2,000 rpm, more preferably at 800 rpm, for 3 to 7 minutes;
e. obtaining a microalgae-based egg substitute.

8. Use of the egg substitute according to claim 1 in the preparation of a food product, preferably in the preparation of sponge cakes, dessert bases, dessert dough, patisseries, viennoiseries, bakery products, or cookies.

9. A method for incorporating the microalgae-based egg substitute according to claim 1 into a food product, comprising incorporating between 0.5 and 5%, by the total weight of the food product, of the microalgae-based egg substitute according to the invention into the preparation of the food product.

10. A food product comprising between 0.5 and 5%, by weight of said food product, of the microalgae-based egg substitute according to claim 1.
